(19) United States
(12) Patent Application Publication
(10) Pub. No.: US 2008/0190010 A1
(43) Pub. Date: Aug. 14, 2008

(54) BAIT HOLDER FOR FISHING

(75) Inventor: RYAN NEAL, Claremore, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: W.C. BRADLEY/ZEBCO HOLDINGS, INC., Tulsa, OK (US)

(21) Appl. No.: 11/673,861

(22) Filed: Feb. 12, 2007

(51) Int. Cl. A01K 97/04

(52) U.S. Cl. 43/55

(57) ABSTRACT

A device for transportation and selective release of live bait organisms is disclosed. The device has a ventilated body providing a plurality of ventilation openings, a lid having a lid base adapted to interfit with the ventilated body and tapering to an opening defined opposite the base. The opening is wide enough to allow only a single bait organism to pass. The lid has a trap door sprung in a normally closed position to cover the opening. A base is adapted to interfit with the ventilated body and provide at least one tackle storage compartment.

### FIELD OF THE INVENTION

This disclosure relates to live bait containers in general and, more specifically, to cricket tube containers.

### BACKGROUND OF THE INVENTION

When fishing, live baits may be preferred over artificial lures for various reasons. Live baits present a number of problems, particularly in handling, transporting, and storing the baits prior to and during their use. The baits must be kept alive or viable and the baits must be moved from their purchase or capture location to the fishing location. Once on location, the baits need to be easily accessible while being kept alive or viable. Some lives baits, such as crickets, can also be dirty to handle such that a user may wish to have a container that at least partially shields the user from the associated droppings or other detritus from the live bait.

What is needed is a system, method, and device for addressing the above and related issues.

### SUMMARY OF THE INVENTION

The present invention disclosed and claimed herein, in one aspect thereof, comprises a device for transportation and selective release of live bait organisms. The device comprises a ventilated body providing a plurality of ventilation openings, a lid having a lid base adapted to interfit with the ventilated body and tapering to an opening defined opposite the base. The opening is wide enough to allow only a single bait organism to pass. The lid has a trap door sprung in a normally closed position to cover the opening. A base is adapted to interfit with the ventilated body and provide at least one tackle storage compartment.

The present invention disclosed and claimed herein, in another aspect thereof, comprises a cricket tube for selectively dispensing a cricket. The cricket tube comprises a substantially tubular body defining a plurality of ventilation holes along a first side and providing a solid surface on an opposite side, a lid attached to the tubular body on a first end thereof and tapering to an opening defined in the lid, the opening being sized to pass a single cricket, a trapdoor attached to the lid and configured to selectively cover the opening in the lid, and a base attached to the tubular body on a second end thereof. The base provides at least one tackle storage compartment.

In some embodiments, the lid will have a lid base and a hinged fill cap. The is attached to the tubular body on a first end thereof and the hinged fill cap defines an opening sized to pass a single cricket such that when closed only a single cricket at a time may pass into or out of the cricket tube and when open a plurality of crickets may be passed simultaneously into or out of the cricket tube. A trapdoor attaches to the hinged fill cap and is configured to selectively cover the cricket sized opening. The at least one tackle storage compartment may be operable to remain closed via an interference fit. The lid and base may also each define a flat portion for stabilizing the cricket tube against rolling when stored horizontally on a flat surface.

### BRIEF DESCRIPTION OF THE DRAWINGS

The present invention is illustrated by way of example and is not limited by the figures of the accompanying drawings, in which like reference numbers indicate similar parts:

FIG. 1 is a top down view of a cricket tube according to aspects of the present disclosure.

FIG. 2 is a cross sectional view of the cricket tube of FIG. 1 taken along the line 2 of FIG. 1.

FIG. 3 is a side cutaway view of the cricket tube of FIG. 1 taken along the line 3 of FIG. 1.

FIG. 4 is a cross sectional view taken along the line 3 of FIG. 3.

FIG. 5 is a cross sectional view of an upper portion of a cricket tube according to aspects of the present disclosure.

FIG. 6 is a perspective view of a cricket tube with the lid removed according to aspects of the present disclosure.

### DETAILED DESCRIPTION OF THE PREFERRED EMBODIMENTS

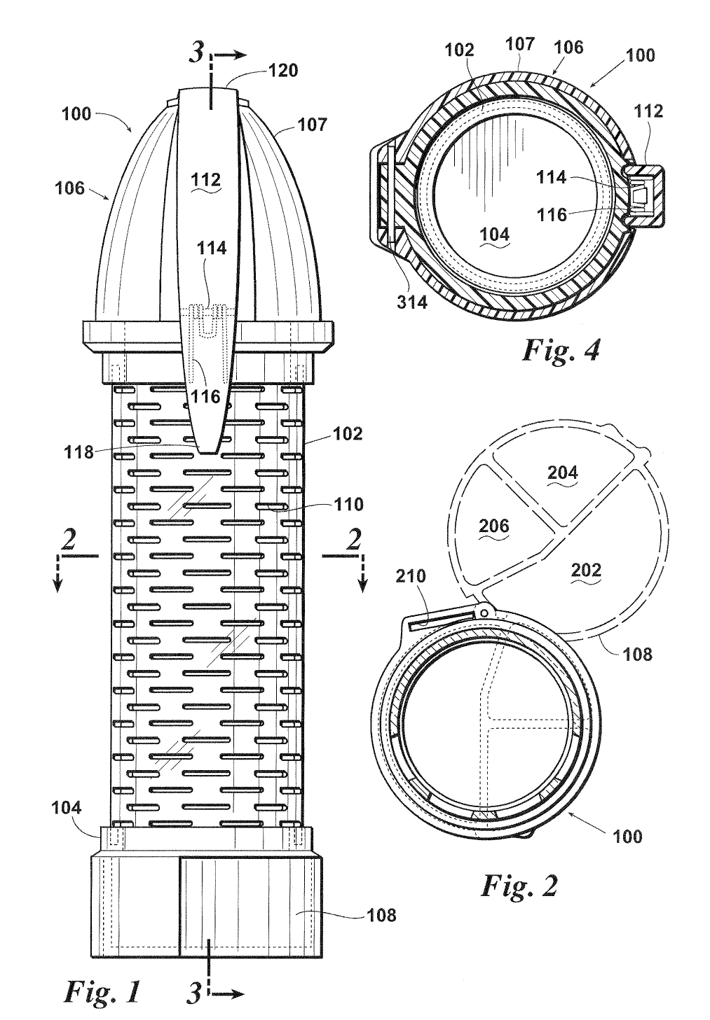

Referring now to FIG. 1, a side view of a cricket tube according to aspects of the present disclosure is shown. The cricket tube 100 comprises a body 102, a base 104, and a multi-function lid 106. The body 102 serves as the primary containment mechanism for live bait organisms. Although the exemplary embodiments shown and described herein are referred to as being cricket tubes, it is understood that live bait organisms other than crickets can be contained and/or handled by the devices shown and described herein. Such live bait organisms may include, but are not limited to, crickets, grasshoppers and other insects, and possibly grubs or other larvae. The base 104 caps off the lower end of the body 102 while the multi-function lid 106 caps off the upper end of the body 102. The full functionality of the multi-function lid 106 will be described in greater detail below.

In the present embodiment, the cricket tube 100 has a base 104 with an integrated storage compartment 108. It can be seen from FIG. 1 and the other drawings that the storage compartment 108 may fit entirely within the base 104. In some embodiments, the storage compartment 108 closes via an interference fit, but in other embodiments, other closing mechanisms are possible. The base 104 may be constructed of a plastic, metal, or another suitably resilient material. In some embodiments, the base 104 may be impact resistant to impart durability to the cricket tube 100. The base 104, including the storage compartment 108, could be manufactured by casting, machining, or other processes.

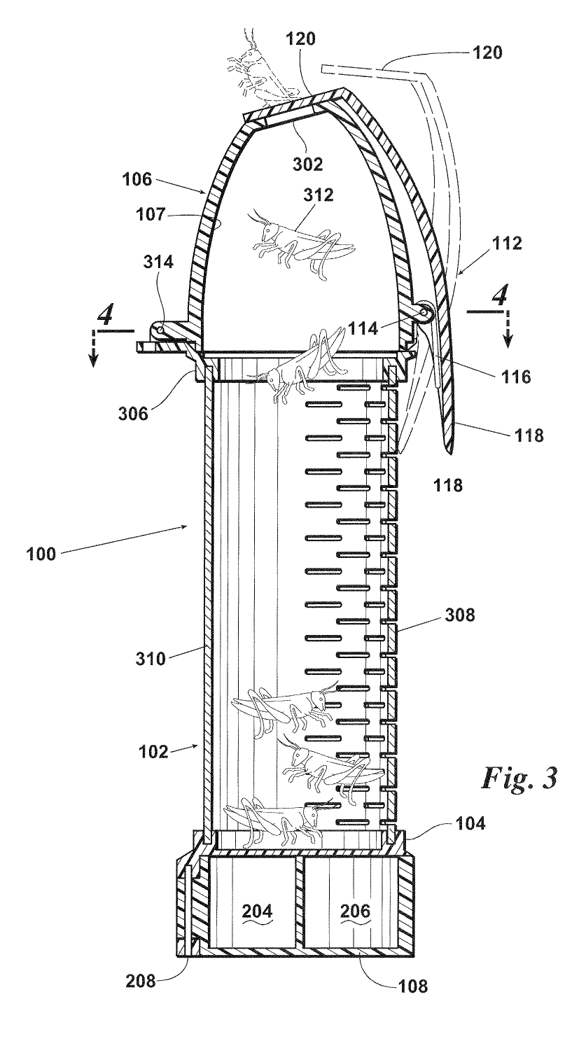

The body 102 serves as the primary containment mechanism for the live bait organisms as previously stated. It can also be seen that the body 102 in the current embodiment defines a number of openings or holes 110. These holes 110 serve to provide ventilation to allow the organisms contained within the cricket tube 100 to remain viable. In some embodiments, the holes 110 may be defined only on a portion of the body 102 such that the cricket tube 100 may be handled without exposing the user to droppings, debris, or other detritus that may be able to pass through the openings 110. This can better be appreciated from FIGS. 3, 5, and 6 as will be described in greater detail below. In some embodiments, the body 102 will be made from a translucent material to allow a user to easily ascertain the condition and quantity of organisms remaining within the cricket tube 100. In such embodiments, the body 102 may be made from a suitably resilient and translucent plastic, for example. The base 104 may be attached to the body 102 by an interference fit, by gluing, or by other means.

The multi-function lid 106 sits atop the body 102 and may be used for both filling and dispensing of live bait organisms. A trap door 112 is provided for dispensing live bait organisms one at a time or in small quantities. The trap door 112 rotates about a hinge 114 which may also have a spring 116 biasing the trap door 112 in a closed position. A tab 118 may be provided on trap door 112 such that pressure on the tab 118 will rotate the trap door 112 about the hinge 114 against the bias of the spring 116 opening a cover 120 that closes an opening 302 (FIG. 3) at or near the end of the multi-function lid 106. In this manner, a user may depress the tab 118 while the opening 302 is in a downward position relative to the rest of the cricket tube 100 and live bait organisms may be dispensed singularly or in small quantities. The multi-function lid 106, including the trap door 112, may be made from plastics, metals, or other suitable materials. The pieces may be formed by casting, machining, or other appropriate methods. In some embodiments, the multi-function lid 106 attaches to the body 102 by an interference fit, but in other embodiments, the multi-function lid 106 may be permanently attached to the body 102 by gluing, for example.

Referring now to FIG. 2, a cross-sectional view of the cricket tube of FIG. 1 taken along line 2 of FIG. 1 is shown. FIG. 2 illustrates the storage compartment 108 in a closed position in dotted line and in an open position in dashed line. It can be seen that in some embodiments the storage compartment 108 may be further divided into sub-compartments 202, 204, and 206. Although three sub-compartments are shown, more or fewer or none at all may be present in other embodiments. It can also be seen that the general shape of the cricket tube 100 is round or tubular and that the storage compartment 108 may open by rotating about a hinge 208. It can also be seen that the base 104 may provide additional features, such as a lanyard loop 210. With the lanyard loop 210, a user may attach a lanyard or other tie to the cricket tube 100 and secure the cricket tube 100 to a convenient location. Lanyards or other securement means may also be attached elsewhere on the cricket tube 100 (e.g., such as to the hinge 314 of FIG. 3 described below).

Referring now to FIG. 3, a side cutaway view of the cricket tube of FIG. 1 taken along the line 3 of FIG. 1 is shown. Here, the trap door 112 is shown in a closed position in solid line and in an open position in dashed line. The opening 302 in the end of the multi-function lid 106 may be sized to appropriately deliver one or only a few bait organisms such as the crickets 312 shown in FIG. 3. It can also be seen that an upper portion 107 of the multi-function lid 106 may taper from a size approximating the width of the body 102 down to the size of the opening 302. In some embodiments, the multi-function lid 106 may be hinged by a hinge 314 to allow the upper portion 107 of the lid 106 to separate from a base portion of the lid 306. In these embodiments, the base portion 306 of the lid 106 may remain attached to the body 102 while the upper portion 107 of the lid 106 is opened, thereby creating a wide opening for filling of the cricket tube body 102. It an also be seen from FIG. 3 that the cricket tube 100 could be held in the palm of a user's hand in a horizontal position, thereby allowing thumb operation of the tab 118. It will be appreciated, however, that the tab 118 is not limited to thumb operation.

As described, the holes or openings 110 are only defined on a first portion 308 of the body 102. Therefore a user may hold the cricket tube 100 in the palm of the hand by a second portion 310 of the body 102, and thereby operate the trap door 112 without coming into contact with undesirable material that may be contained within the cricket tube body 102. In addition, the cricket tube 100 may be configured such that the second portion 310 of the body 102 is down when the cricket tube is laying horizontally on a flat surface. The lid 106 and/or the base 104 may provide flat portions (flats) on which the cricket tube may rest when laying down. Such flat portions stabilize the cricket tube 100 in a horizontal position and prevent it from rolling. In the embodiment of FIG. 3, these flat portions may be formed by or near the hinge 314 of the lid 106 and by the lanyard loop 208 of the base 104. In other embodiments, the flats may be provided separately or on a different location on the lid 106 and/or the base 104. Flats or other stabilizing features could also be formed directly on the body 102 of the cricket tube 100. When the cricket tube 100 is laying on the flats with second portion 310 of the body 102 facing downward, the solid surface of the second portion 310 of the body 102 prevents debris from dropping out of the cricket tube 100.

Referring now to FIG. 4, a cross-sectional view taken along the line 4 of FIG. 3 is shown. From this viewpoint looking down the cricket tube body 102, the base 104 can be seen, as well as the multi-function lid 106 sitting atop the body 102. The lid hinge 314 can be seen located opposite the trap door 112. Here, the trap door hinge 114 and spring 116 can also be seen. Although the spring 116 in the current embodiment is a coil spring, in other embodiments, other types of springs are possible. Additionally, in other embodiments, the trap door 112 may provide an interference fit against the upper portion 107 of the lid 106 and/or the opening 302 such that a spring may not be needed.

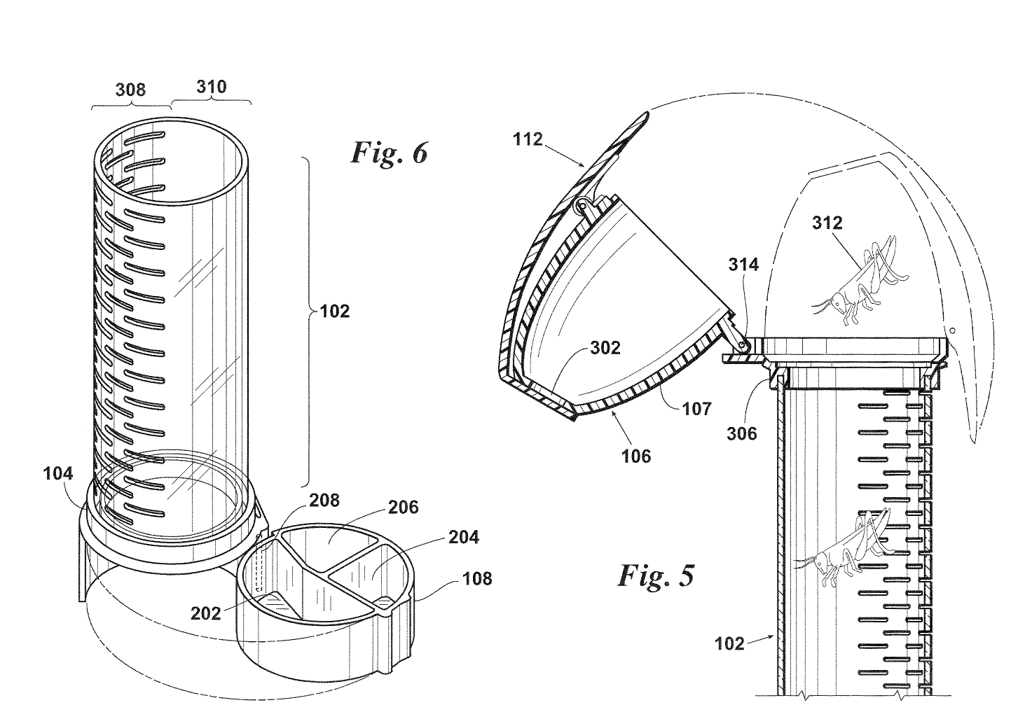

Referring now to FIG. 5, a cross-sectional view of an upper portion of a cricket tube according to aspects of the present disclosure is shown. Here, the multi-function lid 106 is shown in an open position in solid line and shown in a closed position in dashed line. From this viewpoint, it can be seen that the multi-function lid 106 may be opened on the hinge 314 to allow for rapid or easy filling of the cricket tube 100 with live bait organisms 312. The upper portion 107 of the lid 106 may fit into the lid base 306 by an interference fit, by a snap fit, or by other suitable means.

Referring now to FIG. 6, a perspective view of a cricket tube with the multi-function lid removed according to aspects of the present disclosure is shown. From this viewpoint, it can be appreciated that the holes 110 may be defined only in the first portion 308 of the body 102 while the second portion 310 may be solid so as to prevent a user from coming into contact with undesirable material within the cricket tube 100. Although the body 102 shown in the present embodiments is substantially circular in cross section, and cylindrical or tubular in shape, other embodiments may have other shapes. FIG. 6 also provides an additional vantage point illustrating the storage compartment 108 opened about the hinge 208 away from the base 104. Although in the embodiments shown and described herein the base 104 provides a storage compartment 108 rotating away from the axis of the body 102, in other embodiments, other fit and access means are possible.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A device for transportation and selective release of live bait organisms, the device comprising:
a ventilated body providing a plurality of ventilation openings;
a lid having a lid base adapted to interfit with the ventilated body and tapering to an opening defined opposite the base, the opening being wide enough to allow only a single bait organism to pass, the lid having a trap door sprung in a normally closed position to cover the opening; and
a base adapted to interfit with the ventilated body and providing at least one tackle storage compartment.

2. The device of claim 1, wherein the base provides a friction fit storage compartment.

3. The device of claim 1, wherein the base provides a friction fit storage compartment with a plurality of tackle storage subcompartments.

4. The device of claim 1, wherein the plurality of ventilation openings covers approximately half of the ventilated body.

5. The device of claim 1, wherein the ventilated body is substantially tubular with ventilation openings on approximately 180 degrees of a circumference of the body.

6. The device of claim 1, wherein the trap door is operable to open by depressing an opening tab, the opening tab aligned with the axis of the ventilated body proximate the plurality of ventilation openings.

7. The device of claim 1, wherein the ventilated body comprises a translucent material.

8. The device of claim 1, wherein the lid further comprises a cover interfitted with the lid base and hinged to the lid base, the cover tapering to the opening and wherein the cover provides a hinged mount for the trapdoor.

9. The device of claim 1, wherein the base defines a lanyard loop.

10. The device of claim 1, wherein the opening defined in the lid is approximately sized to accommodate a cricket.

11. A cricket tube for selectively dispensing a cricket, the cricket tube comprising:
a substantially tubular body defining a plurality of ventilation holes along a first side and providing a solid surface on an opposite side;
a lid attached to the tubular body on a first end thereof and tapering to an opening defined in the lid, the opening being sized to pass a single cricket;
a trapdoor attached to the lid and configured to selectively cover the opening in the lid; and
a base attached to the tubular body on a second end thereof;
wherein the lid and base each define at least one relatively flat portion for stabilizing the cricket tube against rolling when lying on a flat surface in horizontal position.

12. The cricket tube of claim 1, wherein the trapdoor is attached to the lid via a hinged spring, the spring configured to hold the trapdoor in a position covering the opening.

13. The cricket tube of claim 12, wherein the trapdoor provides a release tab operable to move the trapdoor into an open position thereby uncovering the opening.

14. The cricket tube of claim 11, wherein the tubular body is substantially translucent.

15. The cricket tube of claim 11, wherein the base provides a tackle storage compartment.

16. The cricket tube of claim 15, wherein the tackle storage compartment is held in a closed position by an interference fit.

17. The cricket tube of claim 11, wherein the lid provides a hinged opening sized to pass a plurality of crickets at once to allow filling of the cricket tube.

18. A cricket tube for selectively dispensing crickets, the cricket tube comprising:
a substantially tubular body defining a plurality of ventilation openings along a first side and providing a solid surface on an opposite side;
a lid with a lid base and a hinged fill cap, the base being attached to the tubular body on a first end thereof and the hinged fill cap defining an opening sized to pass a single cricket such that when closed only a single cricket at a time may pass into or out of the cricket tube and when open a plurality of crickets may be passed simultaneously into or out of the cricket tube;
a trapdoor attached to the hinged fill cap and configured to selectively cover the cricket sized opening; and
a cricket tube base attached to the tubular body on a second end thereof, the base providing at least one tackle storage compartment and operable to remain closed via an interference fit;
wherein a flat portion is provided on each of the base and the lid for stabilizing the cricket tube against rolling when placed on a flat surface in a horizontal position.

19. The cricket tube of claim 18, wherein the trapdoor is attached to the hinged fill cap via a spring loaded hinge configured to hold the trapdoor closed over the cricket sized opening.

20. The cricket tube of claim 18, wherein the trapdoor provides a release tab for selectively opening the trapdoor against the resistance of the spring loaded hinge, the tab being provided along the axis of the substantially tubular body such that the cricket tube may be held in an operator's hand while the release tab is actuated by the thumb of the operator's hand.
